(19) United States
(12) Patent Application Publication
(10) Pub. No.: US 2026/0048855 A1
(43) Pub. Date: Feb. 19, 2026

(54) SYSTEMS, APPARATUSES, METHODS, AND COMPUTER PROGRAM PRODUCTS FOR AIRCRAFT CONNECTIVITY

(71) Applicant: Honeywell International Inc., Charlotte, NC (US)

(72) Inventors: Ranjani Tumkur Venkataramaiah, Bangalore (IN); Nathan Krishnamoorthy, Bangalore (IN); Sreenivasan Govindillam, Bengaluru (IN); Sri Harsha Kosuri, Bangalore (IN)

(21) Appl. No.: 18/901,675

(22) Filed: Sep. 30, 2024

(30) Foreign Application Priority Data
Aug. 16, 2024 (IN) 202411062087

(51) Int. Cl. B64D 45/00

(52) U.S. Cl. CPC B64D 45/00

(57) ABSTRACT

Systems, apparatuses, methods, and computer program products are provided herein. For example, the method includes identifying historical aircraft connectivity data. In some embodiments, the method includes training an aircraft connectivity prediction model using the historical aircraft connectivity data. In some embodiments, the method includes identifying aircraft mission connectivity impact data. In some embodiments, the method includes generating aircraft mission connectivity prediction data by applying the aircraft mission connectivity impact data to the aircraft connectivity prediction model. In some embodiments, the method includes generating an aircraft mission connectivity prediction interface component. In some embodiments, the aircraft mission connectivity prediction interface component comprises one or more aircraft connectivity zone representations. In some embodiments, the method includes causing the aircraft mission connectivity prediction interface component to be rendered to an aircraft operations interface.

### CROSS REFERENCE TO RELATED APPLICATIONS

This application claims the benefit of India Provisional Application No. 202411062087 filed Aug. 16, 2024, and entitled “SYSTEMS, APPARATUSES, METHODS, AND COMPUTER PROGRAM PRODUCTS FOR AIRCRAFT CONNECTIVITY,” which is hereby incorporated by reference in its entirety.

### TECHNOLOGICAL FIELD

Embodiments of the present disclosure relate generally to systems, apparatuses, methods, and computer program products for aircraft connectivity predictions.

### BACKGROUND

Applicant has identified many technical challenges and difficulties associated with aircraft connectivity. Through applied effort, ingenuity, and innovation, Applicant has solved problems related to aircraft connectivity by developing solutions embodied in the present disclosure, which are described in detail below.

### BRIEF SUMMARY

Various embodiments described herein relate to systems, apparatuses, methods, and computer program products for aircraft connectivity.

In accordance with one aspect of the disclosure, a method is provided. In some embodiments, the method includes identifying historical aircraft connectivity data. In some embodiments, the method includes training an aircraft connectivity prediction model using the historical aircraft connectivity data. In some embodiments, the method includes identifying aircraft mission connectivity impact data. In some embodiments, the method includes generating aircraft mission connectivity prediction data by applying the aircraft mission connectivity impact data to the aircraft connectivity prediction model. In some embodiments, the method includes generating an aircraft mission connectivity prediction interface component. In some embodiments, the aircraft mission connectivity prediction interface component comprises one or more aircraft connectivity zone representations. In some embodiments, each of one or more aircraft connectivity zone representations is associated with one of a plurality of connectivity impact levels. In some embodiments, the method includes causing the aircraft mission connectivity prediction interface component to be rendered to an aircraft operations interface.

In some embodiments, the aircraft mission connectivity prediction interface component is associated with an in-flight state.

In some embodiments, the aircraft mission connectivity prediction interface component is associated with an airport state.

In some embodiments, the method includes initiating performance of one or more aircraft connectivity related actions.

In some embodiments, initiating performance of one or more aircraft connectivity related actions includes modifying an aircraft mission associated with an aircraft.

In some embodiments, initiating performance of one or more aircraft connectivity related actions includes performing a runway landing simulation for an aircraft.

In some embodiments, the runway landing simulation is performed when the aircraft is associated with a minimal connectivity impact level of the plurality of connectivity impact levels.

In some embodiments, initiating performance of one or more aircraft connectivity related actions includes performing an optimal altitude simulation for an aircraft.

In some embodiments, the optimal altitude simulation is performed when the aircraft is associated with a minimal connectivity impact level of the plurality of connectivity impact levels.

In some embodiments, initiating performance of one or more aircraft connectivity related actions includes causing operation of one or more aircraft components associated with an aircraft.

In some embodiments, initiating performance of one or more aircraft connectivity related actions includes causing an aircraft connectivity alert to be provided to an operator of an aircraft.

In some embodiments, the aircraft connectivity prediction model comprises a regression learning model.

In some embodiments, the method includes generating a negative connectivity indication display item.

In some embodiments, the method includes generating an aircraft mission visualization interface component.

In some embodiments, the aircraft mission visualization interface component comprises the negative connectivity indication display item.

In some embodiments, the method includes generating a positive connectivity indication display item.

In some embodiments, the method includes generating an aircraft mission visualization interface component.

In some embodiments, the aircraft mission visualization interface component comprises the positive connectivity indication display item.

In accordance with another aspect of the disclosure, an apparatus is provided. In some embodiments, the apparatus comprises memory and one or more processors communicatively coupled to the memory.

In some embodiments, the one or more processors are configured to identify historical aircraft connectivity data. In some embodiments, the one or more processors are configured to train an aircraft connectivity prediction model using the historical aircraft connectivity data. In some embodiments, the one or more processors are configured to identify aircraft mission connectivity impact data. In some embodiments, the one or more processors are configured to generate aircraft mission connectivity prediction data by applying the aircraft mission connectivity impact data to the aircraft connectivity prediction model. In some embodiments, the one or more processors are configured to generate an aircraft mission connectivity prediction interface component. In some embodiments, the aircraft mission connectivity prediction interface component comprises one or more aircraft connectivity zone representations. In some embodiments, each of one or more aircraft connectivity zone representations is associated with one of a plurality of connectivity impact levels. In some embodiments, the one or more processors are configured to cause the aircraft mission connectivity prediction interface component to be rendered to an aircraft operations interface.

In some embodiments, the aircraft mission connectivity prediction interface component is associated with an in-flight state.

In some embodiments, the aircraft mission connectivity prediction interface component is associated with an airport state.

In some embodiments, the one or more processors are configured to initiate performance of one or more aircraft connectivity related actions.

In some embodiments, the aircraft connectivity prediction model comprises a regression learning model.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for identifying historical aircraft connectivity data. In some embodiments, the computer program code, in execution with at least one processor, configures the computer program product for training an aircraft connectivity prediction model using the historical aircraft connectivity data. In some embodiments, the computer program code, in execution with at least one processor, configures the computer program product for identifying aircraft mission connectivity impact data. In some embodiments, the computer program code, in execution with at least one processor, configures the computer program product for generating aircraft mission connectivity prediction data by applying the aircraft mission connectivity impact data to the aircraft connectivity prediction model. In some embodiments, the computer program code, in execution with at least one processor, configures the computer program product for generating an aircraft mission connectivity prediction interface component. In some embodiments, the aircraft mission connectivity prediction interface component comprises one or more aircraft connectivity zone representations. In some embodiments, each of one or more aircraft connectivity zone representations is associated with one of a plurality of connectivity impact levels. In some embodiments, the computer program code, in execution with at least one processor, configures the computer program product for causing the aircraft mission connectivity prediction interface component to be rendered to an aircraft operations interface.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an example interface component in accordance with one or more embodiments of the present disclosure;

FIG. 4 illustrates an example interface component in accordance with one or more embodiments of the present disclosure;

FIG. 5 illustrates an example interface component in accordance with one or more embodiments of the present disclosure;

FIG. 6 illustrates an example interface component in accordance with one or more embodiments of the present disclosure;

FIG. 7 illustrates a flowchart of an example method in accordance with one or more embodiments of the present disclosure;

FIG. 8 illustrates an example interface component in accordance with one or more embodiments of the present disclosure; and

FIG. 9 illustrates an example interface component in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with aircraft connectivity. As would be understood by one skilled in the field to which this disclosure pertains, there are numerous example scenarios in which it may be desirable to manage and/or provide aircraft connectivity.

In many applications, systems, apparatuses, methods, and computer program products for managing and/or providing aircraft connectivity are desirable. In some implementations, it may be desirable to manage and/or provide connectivity between a device external to an aircraft and a device within an aircraft. For example, it may be desirable to manage and/or provide connectivity between a cloud-based aircraft connectivity prediction device, one or more databases 170, and/or the like (e.g., devices external to an aircraft) and a mobile aircraft connectivity prediction device, an onboard aircraft connectivity prediction device 180, one or more aircraft components 190, and/or the like (e.g., devices within an aircraft). In some implementations, it may be desirable to manage and/or provide aircraft connectivity when an aircraft is in-flight. In some implementations it may be desirable to manage and/or provide aircraft connectivity when an aircraft is at an airport. In this way, aircraft connectivity may be provided and/or managed between devices external to an aircraft and devices within an aircraft when the aircraft is in-flight and when the aircraft is at an airport such that the aircraft can perform safe and efficient aircraft missions.

Example solutions for managing and/or providing aircraft connectivity include using a computing device to provide and/or manage connectivity between a device external to an aircraft and a device within an aircraft. However, such example solutions are reactive, inaccurate, simplistic, and static. For example, such example solutions are reactive because such example solutions are unable to proactively predict aircraft connectivity because such example solutions do not contemplate aircraft mission connectivity impact items. In this regard, for example, such example solutions are unable to predict whether there will be connectivity between a device within an aircraft and a device outside of an aircraft at one or more points in a planned aircraft mission. As another example, such example solutions are inaccurate because such example solutions do not contemplate training and implementing an aircraft connectivity prediction model to predict aircraft connectivity. As another example, such example solutions are simplistic because such example solutions do not enable performing an optimal altitude simulation and/or a runway landing simulation for an aircraft. As another example, such example solutions are static because such example solutions do not automatically initiate performance of one or more aircraft connectivity related actions, such as an aircraft connectivity related action that includes modifying an aircraft mission. Accordingly, there is a need for systems, apparatuses, methods, and computer program products for aircraft connectivity that operate in a proactive, accurate, sophisticated, and dynamic manner.

Thus, to address these and/or other issues related to such example solutions, example systems, apparatuses, methods, and computer program products for aircraft connectivity are disclosed herein. For example, an embodiment, in this disclosure, described in greater detail below, includes a method that includes identifying historical aircraft connectivity data. In some embodiments, the method includes training an aircraft connectivity prediction model using the historical aircraft connectivity data. In some embodiments, the method includes identifying aircraft mission connectivity impact data. In some embodiments, the method includes generating aircraft mission connectivity prediction data by applying the aircraft mission connectivity impact data to the aircraft connectivity prediction model. In some embodiments, the method includes generating an aircraft mission connectivity prediction interface component. In some embodiments, the aircraft mission connectivity prediction interface component comprises one or more aircraft connectivity zone representations. In some embodiments, each of one or more aircraft connectivity zone representations is associated with one of a plurality of connectivity impact levels. In some embodiments, the method includes causing the aircraft mission connectivity prediction interface component to be rendered to an aircraft operations interface. Accordingly, the systems, apparatuses, methods, and computer program products disclosed herein enable aircraft connectivity in a proactive, accurate, sophisticated, and dynamic manner.

### Example Systems and Apparatuses

Embodiments of the present disclosure herein include systems, apparatuses, methods, and computer program products configured for aircraft connectivity predictions. It should be readily appreciated that the embodiments of the apparatus, systems, methods, and computer program product described herein may be configured in various additional and alternative manners in addition to those expressly described herein.

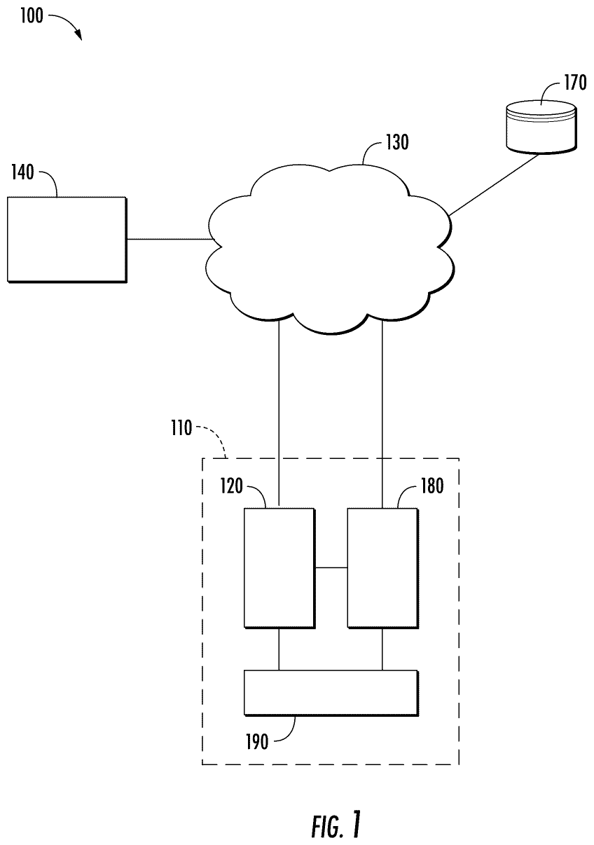

FIG. 1 illustrates an example block diagram of an environment 100 in which embodiments of the present disclosure may operate. Specifically, FIG. 1 illustrates an aircraft 110. In some embodiments, the aircraft 110 may describe any machine, robot, computing devices, and/or apparatus comprised of hardware, software, firmware, and/or any combination thereof, that maneuvers throughout an environment through a medium, such as air. In some contexts, the aircraft 110 is utilized to transport objects, entities (e.g., people, animals, or other beings), and/or other onboard cargo. In some situations, the aircraft 110 may be transporting no object except for the aircraft itself. Examples of the aircraft 110 include airplanes, helicopters, drones, and/or the like. In some embodiments, the aircraft 110 is not limited to the examples listed herein and may include other types of transportation device.

In some embodiments, the aircraft 110 is configured to perform an aircraft mission. In some embodiments, an aircraft mission is a defined series of operations performed by the aircraft 110. For example, may include a defined series of operations performed by the aircraft 110 to move from a first airport to a second airport. In this regard, in some embodiments, an aircraft mission may include a defined series of operations performed by the aircraft 110 that include operations performed while the aircraft 110 is performing preflight procedures (e.g., at the gate before a flight), leaving a gate, taxiing, taking off, in-flight, landing, parking at a gate performing post flight procedures (e.g., at the gate after a flight), and/or the like. For example, an aircraft mission may include a defined series of operations that includes leaving the gate at a first airport, taxiing to a runway at the first airport (e.g., an originating airport), taking off from the first airport, flying to a second airport (e.g., a destination airport), landing at the second airport, taxiing to a gate at the second airport, parking at a gate at the second airport.

In some embodiments, the aircraft 110 is associated with a determinable location. The determinable location of the aircraft 110 in some embodiments represents an absolute position (e.g., GPS coordinates, latitude and longitude locations, an address, and/or the like) or a relative position of the aircraft 110 (e.g., an identifier representing the location of the aircraft 110 as compared to one or more other aircraft, one or more buildings (e.g., an airport), an enterprise headquarters, or general description in the world for example based at least in part on continent, state, ocean, or other definable region). In some embodiments, the aircraft 110 includes or otherwise is associated with a location sensor and/or software-driven location services that provide the location data corresponding to the aircraft 110. In other embodiments, the location of the aircraft 110 is stored and/or otherwise determinable to one or more systems.

In some embodiments, the environment 100 includes a cloud-based aircraft connectivity prediction device 140. In some embodiments, the cloud-based aircraft connectivity prediction device 140 is electronically and/or communicatively coupled to the aircraft 110, a mobile aircraft connectivity prediction device 120, an onboard aircraft connectivity prediction device 180, one or more aircraft components 190, and/or one or more databases 170. The cloud-based aircraft connectivity prediction device 140 may be located remotely from the aircraft 110. In this regard, for example, the cloud-based aircraft connectivity prediction device 140 may be located in a remote cloud server and electronically and/or communicatively coupled to the aircraft 110, the mobile aircraft connectivity prediction device 120, the onboard aircraft connectivity prediction device 180, the one or more aircraft components 190, and/or the one or more databases 170 via at least the network 130. In some embodiments, the cloud-based aircraft connectivity prediction device 140 is configured via hardware, software, firmware, and/or a combination thereof, to perform data intake of one or more types of data, such as historical aircraft connectivity data, real-time aircraft connectivity impact data, aircraft connectivity prediction data, and/or the like.

Additionally, or alternatively, in some embodiments, the cloud-based aircraft connectivity prediction device 140 is configured via hardware, software, firmware, and/or a combination thereof, to generate and/or transmit command(s) that control, adjust, or otherwise impact operations of one or more of the aircraft 110, the mobile aircraft connectivity prediction device 120, the onboard aircraft connectivity prediction device 180, the one or more aircraft components 190, and/or the one or more databases 170. For example, the cloud-based aircraft connectivity prediction device 140 may be configured for aircraft connectivity predictions. Additionally, or alternatively, in some embodiments, the cloud-based aircraft connectivity prediction device 140 is configured via hardware, software, firmware, and/or a combination thereof, to perform data reporting, provide data, and/or other data output process(es) associated with monitoring or otherwise analyzing operations of one or more of the aircraft 110, the mobile aircraft connectivity prediction device 120, the onboard aircraft connectivity prediction device 180, the one or more aircraft components 190, and/or the one or more databases 170. For example, in various embodiments, the cloud-based aircraft connectivity prediction device 140 may be configured to execute and/or perform one or more operations and/or functions described herein.

In some embodiments, the environment 100 includes the mobile aircraft connectivity prediction device 120. In some embodiments, the mobile aircraft connectivity prediction device 120 is electronically and/or communicatively coupled to the aircraft 110, the cloud-based aircraft connectivity prediction device 140, the onboard aircraft connectivity prediction device 180, the one or more aircraft components 190, and/or the one or more databases 170. The mobile aircraft connectivity prediction device 120 may be located remotely from the aircraft 110, in proximity of the aircraft 110 (e.g., with a pilot at an airport gate associated with the aircraft 110), and/or within the aircraft 110 (e.g., with the pilot in the aircraft 110). In this regard, for example, the mobile aircraft connectivity prediction device 120 may be portable. In some embodiments, the mobile aircraft connectivity prediction device 120 is an electronic flight bag. In some embodiments, the mobile aircraft connectivity prediction device 120 is configured via hardware, software, firmware, and/or a combination thereof, to perform data intake of one or more types of data, such as historical aircraft connectivity data, real-time aircraft connectivity impact data, aircraft connectivity prediction data, and/or the like.

Additionally, or alternatively, in some embodiments, the mobile aircraft connectivity prediction device 120 is configured via hardware, software, firmware, and/or a combination thereof, to generate and/or transmit command(s) that control, adjust, or otherwise impact operations of one or more of the aircraft 110, the cloud-based aircraft connectivity prediction device 140, the onboard aircraft connectivity prediction device 180, the one or more aircraft components 190, and/or the one or more databases 170. For example, the mobile aircraft connectivity prediction device 120 may be configured for aircraft connectivity predictions. Additionally, or alternatively, in some embodiments, the mobile aircraft connectivity prediction device 120 is configured via hardware, software, firmware, and/or a combination thereof, to perform data reporting, provide data, and/or other data output process(es) associated with monitoring or otherwise analyzing operations of one or more of the aircraft 110, the cloud-based aircraft connectivity prediction device 140, the onboard aircraft connectivity prediction device 180, the one or more aircraft components 190, and/or the one or more databases 170. For example, in various embodiments, the mobile aircraft connectivity prediction device 120 may be configured to execute and/or perform one or more operations and/or functions described herein.

In some embodiments, the environment 100 includes the onboard aircraft connectivity prediction device 180. In some embodiments, the onboard aircraft connectivity prediction device 180 is electronically and/or communicatively coupled to the aircraft 110, the cloud-based aircraft connectivity prediction device 140, the mobile aircraft connectivity prediction device 120, the one or more aircraft components 190, and/or the one or more databases 170. The onboard aircraft connectivity prediction device 180 may be located within the aircraft 110 (e.g., as a component of the aircraft 110). In this regard, for example, the onboard aircraft connectivity prediction device 180 may physically secured to the aircraft 110. In some embodiments, the onboard aircraft connectivity prediction device 180 may comprise a flight management system (FMS). In some embodiments, the onboard aircraft connectivity prediction device 180 is configured via hardware, software, firmware, and/or a combination thereof, to perform data intake of one or more types of data, such as historical aircraft connectivity data, real-time aircraft connectivity impact data, aircraft connectivity prediction data, and/or the like.

Additionally, or alternatively, in some embodiments, the onboard aircraft connectivity prediction device 180 is configured via hardware, software, firmware, and/or a combination thereof, to generate and/or transmit command(s) that control, adjust, or otherwise impact operations of one or more of the aircraft 110, the cloud-based aircraft connectivity prediction device 140, the mobile aircraft connectivity prediction device 120, the one or more aircraft components 190, and/or the one or more databases 170. For example, the onboard aircraft connectivity prediction device 180 may be configured for aircraft connectivity predictions. Additionally, or alternatively, in some embodiments, the onboard aircraft connectivity prediction device 180 is configured via hardware, software, firmware, and/or a combination thereof, to perform data reporting, provide data, and/or other data output process(es) associated with monitoring or otherwise analyzing operations of one or more of the aircraft 110, the cloud-based aircraft connectivity prediction device 140, the mobile aircraft connectivity prediction device 120, the one or more aircraft components 190, and/or the one or more databases 170. For example, in various embodiments, the onboard aircraft connectivity prediction device 180 may be configured to execute and/or perform one or more operations and/or functions described herein.

In some embodiments, the environment 100 includes the one or more aircraft components 190. In some embodiments, the one or more aircraft components 190 are electronically and/or communicatively coupled to the aircraft 110, the cloud-based aircraft connectivity prediction device 140, the mobile aircraft connectivity prediction device 120, the onboard aircraft connectivity prediction device 180, and/or the one or more databases 170. The one or more aircraft components 190 may be located within the aircraft 110. In this regard, for example may be one or more individual components of the aircraft 110 that perform a particular function during operation of the aircraft 110. For example, the one or more aircraft components 190 may include one or more of multi-function control and display units (MCDU), flight management systems (FMS) (e.g., a secondary flight management system when the onboard aircraft connectivity prediction device 180 is a flight management system), inertial reference systems (IRS), global positioning systems (GPS), sensors, actuators, primary flight displays, radars (e.g., weather radars), engines, auxiliary power units (APU), enhanced ground proximity warning systems (EGPWS), landing gear, flaps, power stations, ailerons, autopilot systems, empennages, and/or the like. In this regard, for example, the individual components of the aircraft 110 may include components associated with a particular process or operation performed by the aircraft 110. In some embodiments, the one or more aircraft components 190 are physically secured to the aircraft 110. In some embodiments, the one or more aircraft components 190 include the onboard aircraft connectivity prediction device 180. In some embodiments, the one or more aircraft components 190 are configured via hardware, software, firmware, and/or a combination thereof, to perform data intake of one or more types of data, such as historical aircraft connectivity data, real-time aircraft connectivity impact data, aircraft connectivity prediction data, and/or the like.

Additionally, or alternatively, in some embodiments, the one or more aircraft components 190 are configured via hardware, software, firmware, and/or a combination thereof, to generate and/or transmit command(s) that control, adjust, or otherwise impact operations of one or more of the aircraft 110, the cloud-based aircraft connectivity prediction device 140, the mobile aircraft connectivity prediction device 120, the onboard aircraft connectivity prediction device 180, and/or the one or more databases 170. For example, the one or more aircraft components 190 may be configured for aircraft connectivity predictions. Additionally, or alternatively, in some embodiments, the one or more aircraft components 190 are configured via hardware, software, firmware, and/or a combination thereof, to perform data reporting, provide data, and/or other data output process(es) associated with monitoring or otherwise analyzing operations of one or more of the aircraft 110, the cloud-based aircraft connectivity prediction device 140, the mobile aircraft connectivity prediction device 120, the onboard aircraft connectivity prediction device 180, and/or the one or more databases 170. For example, in various embodiments, the one or more aircraft components 190 may be configured to execute and/or perform one or more operations and/or functions described herein.

In some embodiments, the environment 100 includes the one or more databases 170. The one or more databases 170 may be configured to receive, store, and/or transmit data. For example, the one or more databases 170 may be configured to receive, store, and/or transmit data associated with the aircraft 110, the cloud-based aircraft connectivity prediction device 140, the mobile aircraft connectivity prediction device 120, the one or more databases 170, the one or more aircraft components 190, and/or the onboard aircraft connectivity prediction device 180. In this regard, for example, the one or more databases 170 may be configured to receive, store, and/or transmit data such as historical aircraft connectivity data, real-time aircraft connectivity impact data, aircraft connectivity prediction data, and/or the like. The one or more databases 170 may be located remotely from the aircraft 110, in proximity of the aircraft 110, and/or within the aircraft 110.

In some embodiments, the environment 100 includes the network 130. The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the cloud-based aircraft connectivity prediction device 140 may include the one or more databases 170.

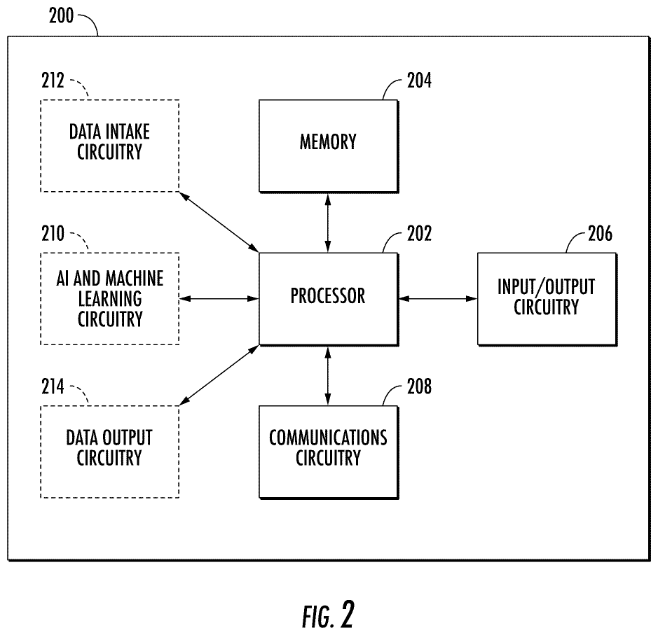

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, the aircraft 110, the cloud-based aircraft connectivity prediction device 140, the mobile aircraft connectivity prediction device 120, the one or more databases 170, the one or more aircraft components 190, and/or the onboard aircraft connectivity prediction device 180. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of the cloud-based aircraft connectivity prediction device 140, the mobile aircraft connectivity prediction device 120, the one or more databases 170, the one or more aircraft components 190, and/or the onboard aircraft connectivity prediction device 180 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the aircraft 110. In some embodiments, the data intake circuitry 212 includes hardware, software, firmware, and/or a combination thereof, that communicates with one or more sensor(s) component(s), and/or the like within the aircraft 110 to receive particular data associated with such operations of the aircraft 110. Additionally, or alternatively, in some embodiments, the data intake circuitry 212 includes hardware, software, firmware, and/or a combination thereof, that retrieves particular data associated with the aircraft 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

In some embodiments, the cloud-based aircraft connectivity prediction device 140, the onboard aircraft connectivity prediction device 180, and/or the mobile aircraft connectivity prediction device 120 is configured to identify historical aircraft connectivity data. In some embodiments, historical aircraft connectivity data includes one or more items of data representative and/or indicative of one or more historical connectivity impact items. In some embodiments, a historical connectivity impact item is an item that has disrupted communication between a device external to an aircraft (e.g., a cloud-based device, a global positioning system satellite, an external communications device, etc.) and a device within an aircraft (e.g., an electronic flight bag, a flight management system, etc.) during a historical aircraft mission (e.g., an aircraft mission previously performed by the aircraft 110 and/or one or more other aircraft). In some embodiments, communication between a device external to an aircraft and a device within an aircraft is disrupted when data transmission between the device external to an aircraft and the device within an aircraft is disrupted (e.g., data transmission is prevented, slowed down, throttled, etc.).

In some embodiments, a historical connectivity impact item includes one or more terrain features (e.g., a mountain, the curvature of the earth, etc.) associated with a historical aircraft mission. In this regard, for example, a terrain feature may have disrupted communication between a device external to an aircraft and a device within an aircraft (e.g., by physically blocking communication) during a historical aircraft mission. In some embodiments, a historical connectivity impact item includes satellite coverage associated with a historical aircraft mission. In this regard, for example, communication between a device external to an aircraft and a device within an aircraft may have been disrupted in an area with poor satellite coverage during a historical aircraft mission. In some embodiments, a historical connectivity impact item includes one or more obstacles (e.g., a building) associated with a historical aircraft mission. In this regard, for example, a building may have disrupted communication between a device external to an aircraft and a device within an aircraft (e.g., by physically blocking communication) during a historical aircraft mission. In some embodiments, a historical connectivity impact item includes atmospheric noise associated with a historical aircraft mission. In this regard, for example, atmospheric noise may have disrupted communication between a device external to an aircraft and a device within an aircraft during a historical aircraft mission.

In some embodiments, a historical connectivity impact item includes ground noise associated with a historical aircraft mission. In this regard, for example, ground noise may have disrupted communication between a device external to an aircraft and a device within an aircraft during a historical aircraft mission. In some embodiments, a historical connectivity impact item includes cosmic noise (e.g., solar flares) associated with a historical aircraft mission. In this regard, for example, cosmic noise may have disrupted communication between a device external to an aircraft and a device within an aircraft during a historical aircraft mission. In some embodiments, a historical connectivity impact item includes ground noise associated with a historical aircraft mission. In this regard, for example, ground noise may have disrupted communication between a device external to an aircraft and a device within an aircraft during a historical aircraft mission. In some embodiments, a historical connectivity impact item includes interfering noise associated with a historical aircraft mission. In this regard, for example, multipath fading may have disrupted communication between a device external to an aircraft and a device within an aircraft during a historical aircraft mission. In some embodiments, a historical connectivity impact item includes rainfall noise associated with a historical aircraft mission. In this regard, for example, rainfall noise may have disrupted communication between a device external to an aircraft and a device within an aircraft during a historical aircraft mission.

In some embodiments, identifying historical aircraft connectivity data includes the cloud-based aircraft connectivity prediction device 140, the onboard aircraft connectivity prediction device 180, and/or the mobile aircraft connectivity prediction device 120 being configured to receive historical aircraft connectivity data. In some embodiments, the cloud-based aircraft connectivity prediction device 140, the onboard aircraft connectivity prediction device 180, and/or the mobile aircraft connectivity prediction device 120 is configured to receive historical aircraft connectivity data from one or more external data sources. For example, the cloud-based aircraft connectivity prediction device 140, the onboard aircraft connectivity prediction device 180, and/or the mobile aircraft connectivity prediction device 120 may receive historical aircraft connectivity data from the one or more databases 170. As another example, the cloud-based aircraft connectivity prediction device 140, the onboard aircraft connectivity prediction device 180, and/or the mobile aircraft connectivity prediction device 120 may receive historical aircraft connectivity data from one or more other aircraft and/or the aircraft 110 (e.g., the one or more aircraft components 190).

In some embodiments, identifying historical aircraft connectivity data includes the cloud-based aircraft connectivity prediction device 140, the onboard aircraft connectivity prediction device 180, and/or the mobile aircraft connectivity prediction device 120 being configured to generate historical aircraft connectivity data. For example, the cloud-based aircraft connectivity prediction device 140, the onboard aircraft connectivity prediction device 180, and/or the mobile aircraft connectivity prediction device 120 may be configured to generate historical aircraft connectivity data using the one or more aircraft components 190.

In some embodiments, the cloud-based aircraft connectivity prediction device 140, the onboard aircraft connectivity prediction device 180, and/or the mobile aircraft connectivity prediction device 120 is configured to train an aircraft connectivity prediction model. In some embodiments, the cloud-based aircraft connectivity prediction device 140, the onboard aircraft connectivity prediction device 180, and/or the mobile aircraft connectivity prediction device 120 is configured to train the aircraft connectivity prediction model using historical aircraft connectivity data. In some embodiments, an aircraft connectivity prediction model is a data entity that describes parameters, hyper-parameters, and/or defined operations of a rules-based and/or machine learning model that is configured to generate aircraft mission connectivity prediction data. In this regard, in some embodiments, the aircraft connectivity prediction model is trained to recognize one or more patterns, make one or more predictions, parse aircraft mission connectivity impact data, and/or the like. In some embodiments, the aircraft connectivity prediction model includes a regression learning model.

In some embodiments, the cloud-based aircraft connectivity prediction device 140, the onboard aircraft connectivity prediction device 180, and/or the mobile aircraft connectivity prediction device 120 is configured to identify aircraft mission connectivity impact data. In some embodiments, aircraft mission connectivity impact data includes one or more items of data representative and/or indicative of one or more aircraft mission connectivity impact items. In some embodiments, an aircraft mission connectivity impact item is an item that may disrupt communication between a device external to the aircraft 110 and a device within the aircraft 110 during a planned aircraft mission of the aircraft 110 (e.g., an upcoming aircraft mission of the aircraft 110). For example, an aircraft mission connectivity impact item may be an item that may disrupt communication between the cloud-based aircraft connectivity prediction device 140, the one or more databases 170, and/or the like and the mobile aircraft connectivity prediction device 120, the onboard aircraft connectivity prediction device 180, and/or the one or more aircraft components 190 during a planned aircraft mission of the aircraft 110.

In some embodiments, an aircraft mission connectivity impact item includes one or more terrain features associated with a planned aircraft mission. For example, an aircraft mission connectivity impact item may include one or more terrain features that are proximate a flight plan that the aircraft 110 is planning to follow in a planned aircraft mission. In some embodiments, an aircraft mission connectivity impact item includes satellite coverage associated with a planned aircraft mission. For example, an aircraft mission connectivity impact item may include satellite coverage for one or more geographic areas that the aircraft 110 will transit through during a planned aircraft mission. In some embodiments, an aircraft mission connectivity impact item includes one or more obstacles (e.g., buildings) associated with a planned aircraft mission. For example, an aircraft mission connectivity impact item may include one or more obstacles that are near an airport where the aircraft 110 will be taking off and/or landing during a planned aircraft mission of the aircraft 110. In some embodiments, an aircraft mission connectivity impact item includes atmospheric noise associated with a planned aircraft mission. For example, an aircraft mission connectivity impact item may include atmospheric noise that is predicted to be present during a planned aircraft mission of the aircraft 110.

In some embodiments, an aircraft mission connectivity impact item includes rainfall noise associated with a planned aircraft mission. For example, an aircraft mission connectivity impact item may include rainfall noise that is predicted to be present during a planned aircraft mission of the aircraft 110. In some embodiments, an aircraft mission connectivity impact item includes ground noise associated with a planned aircraft mission. For example, an aircraft mission connectivity impact item may include ground noise that is predicted to be present during a planned aircraft mission of the aircraft 110. In some embodiments, an aircraft mission connectivity impact item includes cosmic noise associated with a planned aircraft mission. For example, an aircraft mission connectivity impact item may include cosmic noise that is predicted to be present during a planned aircraft mission of the aircraft 110. In some embodiments, an aircraft mission connectivity impact item includes interfering noise associated with a planned aircraft mission. For example, an aircraft mission connectivity impact item may include interfering noise that is predicted to be present during a planned aircraft mission of the aircraft 110. In some embodiments, an aircraft mission connectivity impact item includes multipath fading associated with a planned aircraft mission. For example, an aircraft mission connectivity impact item may include multipath fading that is predicted to be present during a planned aircraft mission of the aircraft 110.

In some embodiments, identifying aircraft mission connectivity impact data includes the cloud-based aircraft connectivity prediction device 140, the onboard aircraft connectivity prediction device 180, and/or the mobile aircraft connectivity prediction device 120 being configured to receive aircraft mission connectivity impact data. In some embodiments, the cloud-based aircraft connectivity prediction device 140, the onboard aircraft connectivity prediction device 180, and/or the mobile aircraft connectivity prediction device 120 is configured to receive aircraft mission connectivity impact data from one or more external data sources. For example, the cloud-based aircraft connectivity prediction device 140, the onboard aircraft connectivity prediction device 180, and/or the mobile aircraft connectivity prediction device 120 may receive aircraft mission connectivity impact data from the one or more databases 170. As another example, the cloud-based aircraft connectivity prediction device 140, the onboard aircraft connectivity prediction device 180, and/or the mobile aircraft connectivity prediction device 120 may receive aircraft mission connectivity impact data from one or more other aircraft and/or the aircraft 110 (e.g., the one or more aircraft components 190).

In some embodiments, identifying aircraft mission connectivity impact data includes the cloud-based aircraft connectivity prediction device 140, the onboard aircraft connectivity prediction device 180, and/or the mobile aircraft connectivity prediction device 120 being configured to generate aircraft mission connectivity impact data. For example, the cloud-based aircraft connectivity prediction device 140, the onboard aircraft connectivity prediction device 180, and/or the mobile aircraft connectivity prediction device 120 may be configured to generate aircraft mission connectivity impact data using the one or more aircraft components 190.

In some embodiments, the cloud-based aircraft connectivity prediction device 140, the onboard aircraft connectivity prediction device 180, and/or the mobile aircraft connectivity prediction device 120 is configured to generate aircraft mission connectivity prediction data. In some embodiments, aircraft mission connectivity prediction data includes one or more items of data representative and/or indicative of one or more aircraft connectivity zone items associated with a planned aircraft mission of the aircraft 110. In some embodiments, an aircraft connectivity zone item is representative and/or indicative of a connectivity impact level of a plurality of connectivity impact levels for a geographic region associated with a planned aircraft mission of the aircraft 110. In this regard, in some embodiments, an aircraft connectivity zone item is representative and/or indicative of a connectivity impact level of a plurality of connectivity impact levels for a geographic region in proximity to a planned aircraft mission of the aircraft 110. For example, an aircraft connectivity zone item is representative and/or indicative of a connectivity impact level of a plurality of connectivity impact levels for a geographic region at an airport associated with a planned aircraft mission of the aircraft 110 (e.g., a particular area at an originating airport and/or destination airport). As another example, an aircraft connectivity zone item is representative and/or indicative of a connectivity impact level of a plurality of connectivity impact levels for a geographic region along a flight path associated with a planned aircraft mission of the aircraft 110 (e.g., a particular area that the aircraft 110 will transit through and/or transit nearby during an aircraft mission).

In some embodiments, the plurality of connectivity impact levels includes a minimal connectivity impact level. In some embodiments, a minimal connectivity impact level is associated with a geographic region in which there is predicted to be no disruption and/or minimal disruption to communication between a device external to the aircraft 110 and a device within the aircraft 110 during a planned aircraft mission for the aircraft 110. For example, a minimal connectivity impact level is associated with a geographic region in which there is predicted to be no disruption and/or minimal disruption to communication between the cloud-based aircraft connectivity prediction device 140, the one or more databases 170, and/or the like and the mobile aircraft connectivity prediction device 120, the onboard aircraft connectivity prediction device 180, and/or the one or more aircraft components 190 during a planned aircraft mission for the aircraft 110. As another example, a minimal connectivity impact level is associated with a geographic region in which there is predicted to be a strong signal strength between the cloud-based aircraft connectivity prediction device 140, the one or more databases 170, and/or the like and the mobile aircraft connectivity prediction device 120, the onboard aircraft connectivity prediction device 180, and/or the one or more aircraft components 190 during a planned aircraft mission for the aircraft 110.

In some embodiments, the plurality of connectivity impact levels includes a moderate connectivity impact level. In some embodiments, a moderate connectivity impact level is associated with a geographic region in which there is predicted to be moderate disruption to communication between a device external to the aircraft 110 and a device within the aircraft 110 during a planned aircraft mission for the aircraft 110. For example, a moderate connectivity impact level is associated with a geographic region in which there is predicted to be moderate disruption to communication between the cloud-based aircraft connectivity prediction device 140, the one or more databases 170, and/or the like and the mobile aircraft connectivity prediction device 120, the onboard aircraft connectivity prediction device 180, the one or more aircraft components 190 during a planned aircraft mission for the aircraft 110. As another example, a moderate connectivity impact level is associated with a geographic region in which there is predicted to be moderate signal strength between the cloud-based aircraft connectivity prediction device 140, the one or more databases 170, and/or the like and the mobile aircraft connectivity prediction device 120, the onboard aircraft connectivity prediction device 180, and/or the one or more aircraft components 190 during a planned aircraft mission for the aircraft 110.

In some embodiments, the plurality of connectivity impact levels includes a severe connectivity impact level. In some embodiments, a severe connectivity impact level is associated with a geographic region in which there is predicted to be severe disruption to communication between a device external to the aircraft 110 and a device within the aircraft 110 during a planned aircraft mission for the aircraft 110. For example, a severe connectivity impact level is associated with a geographic region in which there is predicted to be severe disruption to communication between the cloud-based aircraft connectivity prediction device 140, the one or more databases 170, and/or the like and the mobile aircraft connectivity prediction device 120, the onboard aircraft connectivity prediction device 180, and/or the one or more aircraft components 190 during a planned aircraft mission for the aircraft 110. As another example, a severe connectivity impact level is associated with a geographic region in which there is predicted to be weak signal strength between the cloud-based aircraft connectivity prediction device 140, the one or more databases 170, and/or the like and the mobile aircraft connectivity prediction device 120, the onboard aircraft connectivity prediction device 180, and/or the one or more aircraft components 190 during a planned aircraft mission for the aircraft 110.

In some embodiments, the cloud-based aircraft connectivity prediction device 140, the onboard aircraft connectivity prediction device 180, and/or the mobile aircraft connectivity prediction device 120 is configured to generate aircraft mission connectivity prediction data by applying aircraft mission connectivity impact data to the aircraft connectivity prediction model. In some embodiments, the cloud-based aircraft connectivity prediction device 140, the onboard aircraft connectivity prediction device 180, and/or the mobile aircraft connectivity prediction device 120 is configured to apply aircraft mission connectivity impact data to the aircraft connectivity prediction model after the aircraft connectivity prediction model is trained.

In some embodiments, the cloud-based aircraft connectivity prediction device 140, the onboard aircraft connectivity prediction device 180, and/or the mobile aircraft connectivity prediction device 120 is configured to generate an aircraft mission connectivity prediction interface component 302. In some embodiments, the aircraft mission connectivity prediction interface component 302 is generated based on aircraft mission connectivity prediction data. In this regard, in some embodiments, the aircraft mission connectivity prediction interface component includes one or more aircraft connectivity zone representations 304.

In some embodiments, each of the one or more aircraft connectivity zone representations 304 is associated with one of the plurality of connectivity impact levels. For example, each of the one or more aircraft connectivity zone representations 304 corresponds to one of the one or more aircraft connectivity zone items. In this regard, in some embodiments, each of the one or more aircraft connectivity zone representations 304 indicates a connectivity impact level of a plurality of connectivity impact levels for a geographic region associated with a planned aircraft mission of the aircraft 110. In this regard, for example, an aircraft connectivity zone representation may include text, color, hatching, symbols, and/or the like that indicate that the aircraft connectivity zone representation is associated with a minimal connectivity impact level (e.g., the aircraft connectivity zone representation may be green on the aircraft mission connectivity prediction interface component 302). As another example, an aircraft connectivity zone representation may include text, color, hatching, symbols, and/or the like that indicate that the aircraft connectivity zone representation is associated with a moderate connectivity impact level (e.g., the aircraft connectivity zone representation may be orange on the aircraft mission connectivity prediction interface component 302). As another example, an aircraft connectivity zone representation may include text, color, hatching, symbols, and/or the like that indicate that the aircraft connectivity zone representation is associated with a severe connectivity impact level (e.g., the aircraft connectivity zone representation may be red on the aircraft mission connectivity prediction interface component 302).

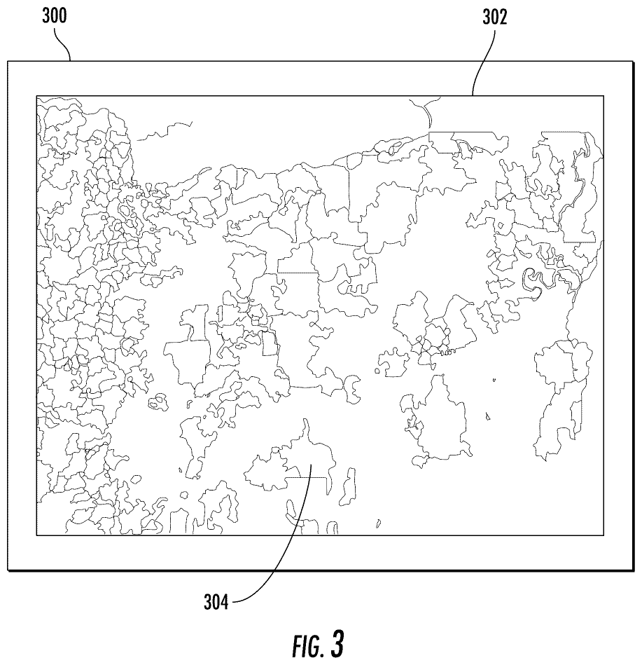

In some embodiments, such as illustrated in FIG. 3, the aircraft mission connectivity prediction interface component 302 is associated with an in-flight state. For example, the aircraft mission connectivity prediction interface component 302 may be associated with an in-flight state when the aircraft 110 is in an in-flight portion of an aircraft mission. Said differently, for example, the aircraft mission connectivity prediction interface component 302 may be associated with an in-flight state when the aircraft 110 is located between an originating airport and a destination airport.

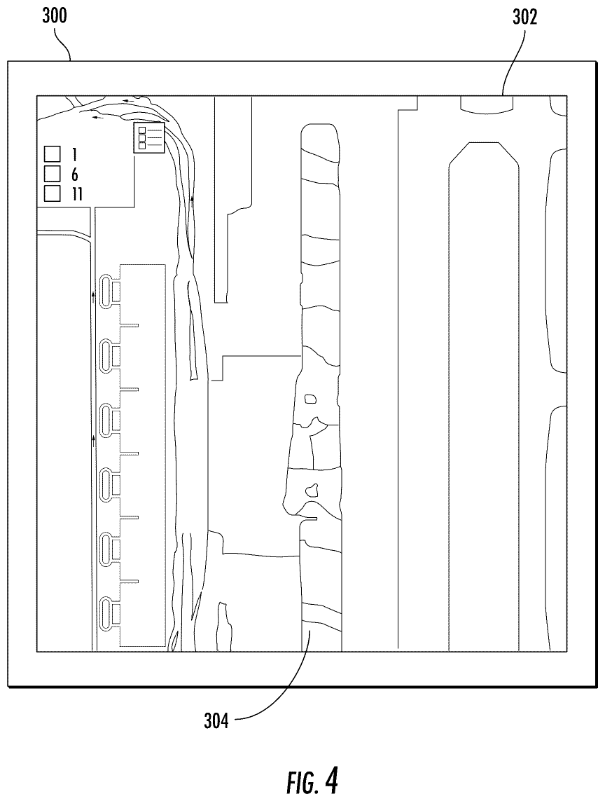

In some embodiments, such as illustrated in FIG. 4, the aircraft mission connectivity prediction interface component 302 is associated with an airport state. For example, the aircraft mission connectivity prediction interface component may be associated with an airport state when the aircraft 110 is in a performing preflight procedures portion (e.g., at the gate before a flight), leaving a gate portion, taxiing portion, taking off portion, landing portion, parking at a gate performing post flight procedures portion (e.g., at the gate after a flight) of an aircraft mission. Said differently, for example, the aircraft mission connectivity prediction interface component 302 may be associated with an airport state when the aircraft 110 is located at an originating airport and/or at a destination airport.

In some embodiments, the cloud-based aircraft connectivity prediction device 140, the onboard aircraft connectivity prediction device 180, and/or the mobile aircraft connectivity prediction device 120 is configured to generate a negative connectivity indication display item 502. In some embodiments, the negative connectivity indication display item 502 is generated based on aircraft mission connectivity prediction data. In this regard, in some embodiments, the negative connectivity indication display item 502 is a display item that includes text, color, hatching, symbols, and/or the like that indicate the aircraft 110 is associated with an aircraft connectivity zone representation that is associated with a moderate connectivity impact level and/or a severe connectivity impact level. Said differently, for example, the negative connectivity indication display item 502 may be configured to indicate that the aircraft 110 is located in a geographic region in which there is moderate and/or severe disruption to communication between a device external to the aircraft 110 and a device within the aircraft 110.

In some embodiments, the cloud-based aircraft connectivity prediction device 140, the onboard aircraft connectivity prediction device 180, and/or the mobile aircraft connectivity prediction device 120 is configured to generate a positive connectivity indication display item 602. In some embodiments, the positive connectivity indication display item 602 is generated based on aircraft mission connectivity prediction data. In this regard, in some embodiments, the positive connectivity indication display item 602 is a display item that includes text, color, hatching, symbols, and/or the like that indicate the aircraft 110 is associated with an aircraft connectivity zone representation that is associated with a minimal connectivity impact level. Said differently, for example, the positive connectivity indication display item 602 may be configured to indicate that the aircraft 110 is located in a geographic region in which there is minimal disruption to communication between a device external to the aircraft 110 and a device within the aircraft 110.

In some embodiments, the cloud-based aircraft connectivity prediction device 140, the onboard aircraft connectivity prediction device 180, and/or the mobile aircraft connectivity prediction device 120 is configured to generate an aircraft mission visualization interface component 500. In some embodiments, the aircraft mission visualization interface component 500 is configured to display various aspects of an aircraft mission associated with the aircraft 110. For example, the aircraft mission visualization interface component 500 may include a representation of the aircraft 110 at the current position of the aircraft 110. In some embodiments, the aircraft mission visualization interface component 500 includes the negative connectivity indication display item 502. For example, the aircraft mission visualization interface component 500 may include the negative connectivity indication display item 502 when the aircraft 110 is associated with an aircraft connectivity zone representation that is associated with a moderate connectivity impact level and/or a severe connectivity impact level. Additionally, or alternatively, the aircraft mission visualization interface component 500 includes the positive connectivity indication display item 602. For example, the aircraft mission visualization interface component 500 may include the positive connectivity indication display item 602 when the aircraft 110 is associated with an aircraft connectivity zone representation that is associated with a minimal connectivity impact level. In some embodiments, the negative connectivity indication display item 502 and/or the positive connectivity indication display item 602 is configured to be selected to display the aircraft mission connectivity prediction interface component 302.

In some embodiments, the cloud-based aircraft connectivity prediction device 140, the onboard aircraft connectivity prediction device 180, and/or the mobile aircraft connectivity prediction device 120 is configured to cause the aircraft mission connectivity prediction interface component 302 to be rendered to an aircraft operations interface 300, such as illustrated in FIG. 3 and FIG. 4. In this regard, in some embodiments, the cloud-based aircraft connectivity prediction device 140, the onboard aircraft connectivity prediction device 180, and/or the mobile aircraft connectivity prediction device 120 is configured to cause the aircraft mission connectivity prediction interface component 302 to be rendered to an aircraft operations interface 300 that is provided on the cloud-based aircraft connectivity prediction device 140, the onboard aircraft connectivity prediction device 180, the mobile aircraft connectivity prediction device 120, and/or the one or more aircraft components 190. For example, the aircraft operations interface 300 may be provided on a multi-function control and display unit.

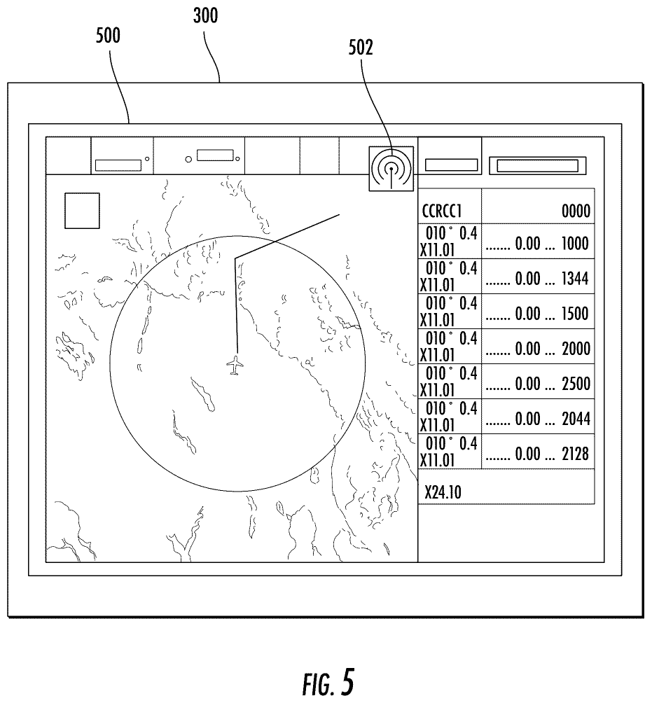

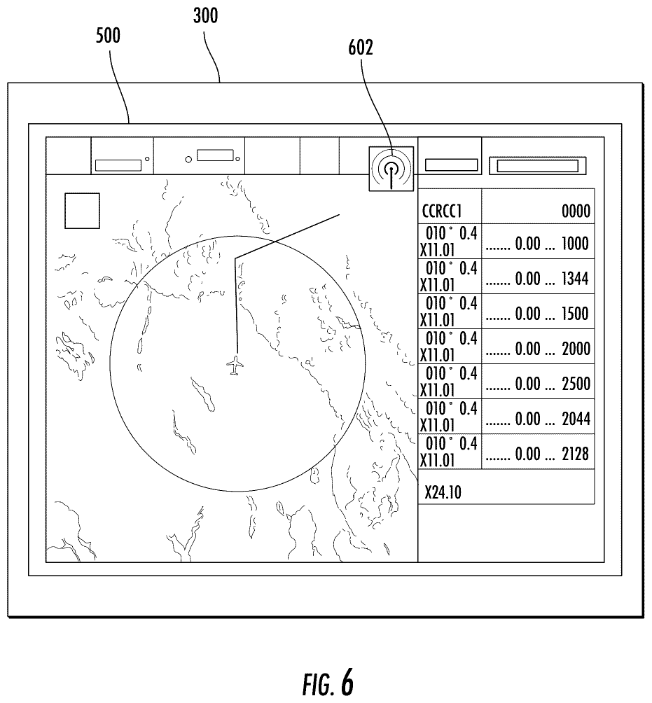

In some embodiments, the cloud-based aircraft connectivity prediction device 140, the onboard aircraft connectivity prediction device 180, and/or the mobile aircraft connectivity prediction device 120 is configured to cause the aircraft mission visualization interface component 500 to be rendered to an aircraft operations interface 300, such as illustrated in FIG. 5 and FIG. 6. In this regard, in some embodiments, the cloud-based aircraft connectivity prediction device 140, the onboard aircraft connectivity prediction device 180, and/or the mobile aircraft connectivity prediction device 120 is configured to cause the aircraft mission visualization interface component 500 to be rendered to an aircraft operations interface 300 that is provided on the cloud-based aircraft connectivity prediction device 140, the onboard aircraft connectivity prediction device 180, the mobile aircraft connectivity prediction device 120, and/or the one or more aircraft components 190. For example, the aircraft operations interface 300 may be provided on a multi-function control and display unit.

In some embodiments, the cloud-based aircraft connectivity prediction device 140, the onboard aircraft connectivity prediction device 180, and/or the mobile aircraft connectivity prediction device 120 is configured to initiate performance of one or more aircraft connectivity related actions. In some embodiments, the cloud-based aircraft connectivity prediction device 140, the onboard aircraft connectivity prediction device 180, and/or the mobile aircraft connectivity prediction device 120 is configured to initiate performance of one or more aircraft connectivity related actions based on the aircraft mission connectivity prediction data. In some embodiments, initiating performance of one or more aircraft connectivity related actions includes modifying an aircraft mission associated with the aircraft 110. For example, an aircraft mission associated with the aircraft 110 may be modified such that the aircraft 110 avoids a geographic area associated with a moderate connectivity impact level and/or a severe connectivity impact level (e.g., a flight plan of the aircraft 110 is changed to avoid a geographic area associated with a moderate connectivity impact level and/or a severe connectivity impact level).

In some embodiments, initiating performance of one or more aircraft connectivity related actions includes performing a runway landing simulation for the aircraft 110. In some embodiments, a runway landing simulation for the aircraft 110 includes simulating one or more operations that will be performed by the cloud-based aircraft connectivity prediction device 140, the onboard aircraft connectivity prediction device 180, the mobile aircraft connectivity prediction device 120, and/or the one or more aircraft components 190 to land the aircraft 110 (e.g., landing at a destination airport). In some embodiments, initiating performance of one or more aircraft connectivity related actions that includes performing a runway landing simulation for the aircraft 110 may be performed when the aircraft 110 is associated with a minimal connectivity impact level (e.g., when the aircraft 110 is located in a geographic region associated with a minimal connectivity impact level).

In some embodiments, initiating performance of one or more aircraft connectivity related actions includes performing an optimal altitude simulation for the aircraft 110. In some embodiments, an optimal altitude simulation for the aircraft 110 includes simulating one or more operations that will be performed by the cloud-based aircraft connectivity prediction device 140, the onboard aircraft connectivity prediction device 180, the mobile aircraft connectivity prediction device 120, and/or the one or more aircraft components 190 to determine an optimal altitude for the aircraft to operate at during one or more portions of an aircraft mission. In some embodiments, initiating performance of one or more aircraft connectivity related actions that includes performing an optimal altitude for the aircraft 110 may be performed when the aircraft 110 is associated with a minimal connectivity impact level (e.g., when the aircraft 110 is located in a geographic region associated with a minimal connectivity impact level).

In some embodiments, initiating performance of one or more aircraft connectivity related actions includes causing operation of the one or more aircraft components 190 of the aircraft 110. For example, initiating performance of one or more aircraft connectivity related actions includes causing operation of a multi-function control and display unit. As another example, initiating performance of one or more aircraft connectivity related actions includes causing operation of a flight management system to cause the aircraft to avoid geographic regions associated with a moderate connectivity impact level and/or a severe connectivity impact level.

In some embodiments, initiating performance of one or more aircraft connectivity related actions includes causing an aircraft connectivity alert to be provided to an operator (e.g., a pilot) of the aircraft 110. In some embodiments, an aircraft connectivity alert is an alert provided to an operator of the aircraft 110 that indicates that the aircraft is approaching a geographic region associated with a moderate connectivity impact level and/or a severe connectivity impact level. In this regard, for example, an aircraft connectivity alert may be configured to alert an operator of the aircraft 110 to perform any communications between a device external to the aircraft 110 and a device within the aircraft 110 before entering a geographic region associated with a moderate connectivity impact level and/or a severe connectivity impact level. In some embodiments, an aircraft connectivity alert is an alert provided to an operator of the aircraft 110 that indicates that the aircraft is in a geographic region associated with a moderate connectivity impact level and/or a severe connectivity impact level. In this regard, for example, an aircraft connectivity alert may be configured to alert an operator of the aircraft 110 that communications between a device external to the aircraft 110 and a device within the aircraft 110 may be disrupted.

### Example Methods

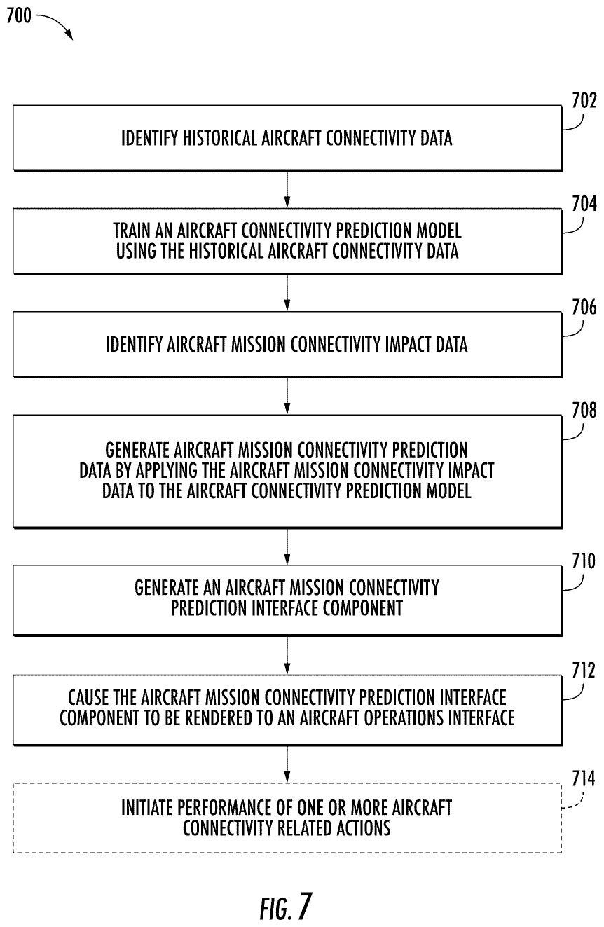

Referring now to FIG. 7, a flowchart providing an example method 700 is illustrated. In this regard, FIG. 7 illustrates operations that may be performed by the cloud-based aircraft connectivity prediction device 140, the mobile aircraft connectivity prediction device 120, an onboard aircraft connectivity prediction device 180, one or more aircraft components 190, and/or one or more databases 170. In some embodiments, the method 700 includes operations for generating an aircraft mission connectivity prediction interface component. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 includes identifying historical aircraft connectivity data. As described above, in some embodiments, historical aircraft connectivity data includes one or more items of data representative and/or indicative of one or more historical connectivity impact items. In some embodiments, a historical connectivity impact item is an item that has disrupted communication between a device external to an aircraft (e.g., a cloud-based device, a global positioning system satellite, an external communications device, etc.) and a device within an aircraft (e.g., an electronic flight bag, a flight management system, etc.) during a historical aircraft mission (e.g., an aircraft mission previously performed by the aircraft and/or one or more other aircraft). In some embodiments, communication between a device external to an aircraft and a device within an aircraft is disrupted when data transmission between the device external to an aircraft and the device within an aircraft is disrupted (e.g., data transmission is prevented, slowed down, throttled, etc.).

In some embodiments, a historical connectivity impact item includes one or more terrain features (e.g., a mountain, the curvature of the earth, etc.) associated with a historical aircraft mission. In this regard, for example, a terrain feature may have disrupted communication between a device external to an aircraft and a device within an aircraft (e.g., by physically blocking communication) during a historical aircraft mission. In some embodiments, a historical connectivity impact item includes satellite coverage associated with a historical aircraft mission. In this regard, for example, communication between a device external to an aircraft and a device within an aircraft may have been disrupted in an area with poor satellite coverage during a historical aircraft mission. In some embodiments, a historical connectivity impact item includes one or more obstacles (e.g., a building) associated with a historical aircraft mission. In this regard, for example, a building may have disrupted communication between a device external to an aircraft and a device within an aircraft (e.g., by physically blocking communication) during a historical aircraft mission. In some embodiments, a historical connectivity impact item includes atmospheric noise associated with a historical aircraft mission. In this regard, for example, atmospheric noise may have disrupted communication between a device external to an aircraft and a device within an aircraft during a historical aircraft mission.

In some embodiments, a historical connectivity impact item includes ground noise associated with a historical aircraft mission. In this regard, for example, ground noise may have disrupted communication between a device external to an aircraft and a device within an aircraft during a historical aircraft mission. In some embodiments, a historical connectivity impact item includes cosmic noise (e.g., solar flares) associated with a historical aircraft mission. In this regard, for example, cosmic noise may have disrupted communication between a device external to an aircraft and a device within an aircraft during a historical aircraft mission. In some embodiments, a historical connectivity impact item includes ground noise associated with a historical aircraft mission. In this regard, for example, ground noise may have disrupted communication between a device external to an aircraft and a device within an aircraft during a historical aircraft mission. In some embodiments, a historical connectivity impact item includes interfering noise associated with a historical aircraft mission. In this regard, for example, multipath fading may have disrupted communication between a device external to an aircraft and a device within an aircraft during a historical aircraft mission. In some embodiments, a historical connectivity impact item includes rainfall noise associated with a historical aircraft mission. In this regard, for example, rainfall noise may have disrupted communication between a device external to an aircraft and a device within an aircraft during a historical aircraft mission.

In some embodiments, identifying historical aircraft connectivity data includes the cloud-based aircraft connectivity prediction device, the onboard aircraft connectivity prediction device, and/or the mobile aircraft connectivity prediction device being configured to receive historical aircraft connectivity data. In some embodiments, the cloud-based aircraft connectivity prediction device, the onboard aircraft connectivity prediction device, and/or the mobile aircraft connectivity prediction device is configured to receive historical aircraft connectivity data from one or more external data sources. For example, the cloud-based aircraft connectivity prediction device, the onboard aircraft connectivity prediction device, and/or the mobile aircraft connectivity prediction device may receive historical aircraft connectivity data from the one or more databases. As another example, the cloud-based aircraft connectivity prediction device, the onboard aircraft connectivity prediction device, and/or the mobile aircraft connectivity prediction device may receive historical aircraft connectivity data from one or more other aircraft and/or the aircraft (e.g., the one or more aircraft components).

In some embodiments, identifying historical aircraft connectivity data includes the cloud-based aircraft connectivity prediction device, the onboard aircraft connectivity prediction device, and/or the mobile aircraft connectivity prediction device being configured to generate historical aircraft connectivity data. For example, the cloud-based aircraft connectivity prediction device, the onboard aircraft connectivity prediction device, and/or the mobile aircraft connectivity prediction device may be configured to generate historical aircraft connectivity data using the one or more aircraft components.

As shown in block 704, the method 700 includes training an aircraft connectivity prediction model using the historical aircraft connectivity data. As described above, in some embodiments, the cloud-based aircraft connectivity prediction device, the onboard aircraft connectivity prediction device, and/or the mobile aircraft connectivity prediction device is configured to train the aircraft connectivity prediction model using historical aircraft connectivity data. In some embodiments, an aircraft connectivity prediction model is a data entity that describes parameters, hyper-parameters, and/or defined operations of a rules-based and/or machine learning model that is configured to generate aircraft mission connectivity prediction data. In this regard, in some embodiments, the aircraft connectivity prediction model is trained to recognize one or more patterns, make one or more predictions, parse aircraft mission connectivity impact data, and/or the like. In some embodiments, the aircraft connectivity prediction model includes a regression learning model.

As shown in block 706, the method 700 includes identifying aircraft mission connectivity impact data. As described above, in some embodiments, aircraft mission connectivity impact data includes one or more items of data representative and/or indicative of one or more aircraft mission connectivity impact items. In some embodiments, an aircraft mission connectivity impact item is an item that may disrupt communication between a device external to the aircraft and a device within the aircraft during a planned aircraft mission of the aircraft (e.g., an upcoming aircraft mission of the aircraft). For example, an aircraft mission connectivity impact item may be an item that may disrupt communication between the cloud-based aircraft connectivity prediction device, the one or more databases, and/or the like and the mobile aircraft connectivity prediction device, the onboard aircraft connectivity prediction device, and/or the one or more aircraft components during a planned aircraft mission of the aircraft.

In some embodiments, an aircraft mission connectivity impact item includes one or more terrain features associated with a planned aircraft mission. For example, an aircraft mission connectivity impact item may include one or more terrain features that are proximate a flight plan that the aircraft is planning to follow in a planned aircraft mission. In some embodiments, an aircraft mission connectivity impact item includes satellite coverage associated with a planned aircraft mission. For example, an aircraft mission connectivity impact item may include satellite coverage for one or more geographic areas that the aircraft will transit through during a planned aircraft mission. In some embodiments, an aircraft mission connectivity impact item includes one or more obstacles (e.g., buildings) associated with a planned aircraft mission. For example, an aircraft mission connectivity impact item may include one or more obstacles that are near an airport where the aircraft will be taking off and/or landing during a planned aircraft mission of the aircraft. In some embodiments, an aircraft mission connectivity impact item includes atmospheric noise associated with a planned aircraft mission. For example, an aircraft mission connectivity impact item may include atmospheric noise that is predicted to be present during a planned aircraft mission of the aircraft.

In some embodiments, an aircraft mission connectivity impact item includes rainfall noise associated with a planned aircraft mission. For example, an aircraft mission connectivity impact item may include rainfall noise that is predicted to be present during a planned aircraft mission of the aircraft. In some embodiments, an aircraft mission connectivity impact item includes ground noise associated with a planned aircraft mission. For example, an aircraft mission connectivity impact item may include ground noise that is predicted to be present during a planned aircraft mission of the aircraft. In some embodiments, an aircraft mission connectivity impact item includes cosmic noise associated with a planned aircraft mission. For example, an aircraft mission connectivity impact item may include cosmic noise that is predicted to be present during a planned aircraft mission of the aircraft. In some embodiments, an aircraft mission connectivity impact item includes interfering noise associated with a planned aircraft mission. For example, an aircraft mission connectivity impact item may include interfering noise that is predicted to be present during a planned aircraft mission of the aircraft. In some embodiments, an aircraft mission connectivity impact item includes multipath fading associated with a planned aircraft mission. For example, an aircraft mission connectivity impact item may include multipath fading that is predicted to be present during a planned aircraft mission of the aircraft.

In some embodiments, identifying aircraft mission connectivity impact data includes the cloud-based aircraft connectivity prediction device, the onboard aircraft connectivity prediction device, and/or the mobile aircraft connectivity prediction device being configured to receive aircraft mission connectivity impact data. In some embodiments, the cloud-based aircraft connectivity prediction device, the onboard aircraft connectivity prediction device, and/or the mobile aircraft connectivity prediction device is configured to receive aircraft mission connectivity impact data from one or more external data sources. For example, the cloud-based aircraft connectivity prediction device, the onboard aircraft connectivity prediction device, and/or the mobile aircraft connectivity prediction device may receive aircraft mission connectivity impact data from the one or more databases. As another example, the cloud-based aircraft connectivity prediction device, the onboard aircraft connectivity prediction device, and/or the mobile aircraft connectivity prediction device may receive aircraft mission connectivity impact data from one or more other aircraft and/or the aircraft (e.g., the one or more aircraft components).

In some embodiments, identifying aircraft mission connectivity impact data includes the cloud-based aircraft connectivity prediction device, the onboard aircraft connectivity prediction device, and/or the mobile aircraft connectivity prediction device being configured to generate aircraft mission connectivity impact data. For example, the cloud-based aircraft connectivity prediction device, the onboard aircraft connectivity prediction device, and/or the mobile aircraft connectivity prediction device may be configured to generate aircraft mission connectivity impact data using the one or more aircraft components.

As shown in block 708, the method 700 includes generating aircraft mission connectivity prediction data by applying the aircraft mission connectivity impact data to the aircraft connectivity prediction model. As described above, in some embodiments, aircraft mission connectivity prediction data includes one or more items of data representative and/or indicative of one or more aircraft connectivity zone items associated with a planned aircraft mission of the aircraft. In some embodiments, an aircraft connectivity zone item is representative and/or indicative of a connectivity impact level of a plurality of connectivity impact levels for a geographic region associated with a planned aircraft mission of the aircraft. In this regard, in some embodiments, an aircraft connectivity zone item is representative and/or indicative of a connectivity impact level of a plurality of connectivity impact levels for a geographic region in proximity to a planned aircraft mission of the aircraft. For example, an aircraft connectivity zone item is representative and/or indicative of a connectivity impact level of a plurality of connectivity impact levels for a geographic region at an airport associated with a planned aircraft mission of the aircraft (e.g., a particular area at an originating airport and/or destination airport). As another example, an aircraft connectivity zone item is representative and/or indicative of a connectivity impact level of a plurality of connectivity impact levels for a geographic region along a flight path associated with a planned aircraft mission of the aircraft (e.g., a particular area that the aircraft will transit through and/or transit nearby during an aircraft mission).

In some embodiments, the plurality of connectivity impact levels includes a minimal connectivity impact level. In some embodiments, a minimal connectivity impact level is associated with a geographic region in which there is predicted to be no disruption and/or minimal disruption to communication between a device external to the aircraft and a device within the aircraft during a planned aircraft mission for the aircraft. For example, a minimal connectivity impact level is associated with a geographic region in which there is predicted to be no disruption and/or minimal disruption to communication between the cloud-based aircraft connectivity prediction device, the one or more databases, and/or the like and the mobile aircraft connectivity prediction device, the onboard aircraft connectivity prediction device, and/or the one or more aircraft components during a planned aircraft mission for the aircraft. As another example, a minimal connectivity impact level is associated with a geographic region in which there is predicted to be a strong signal strength between the cloud-based aircraft connectivity prediction device, the one or more databases, and/or the like and the mobile aircraft connectivity prediction device, the onboard aircraft connectivity prediction device, and/or the one or more aircraft components during a planned aircraft mission for the aircraft.

In some embodiments, the plurality of connectivity impact levels includes a moderate connectivity impact level. In some embodiments, a moderate connectivity impact level is associated with a geographic region in which there is predicted to be moderate disruption to communication between a device external to the aircraft and a device within the aircraft during a planned aircraft mission for the aircraft. For example, a moderate connectivity impact level is associated with a geographic region in which there is predicted to be moderate disruption to communication between the cloud-based aircraft connectivity prediction device, the one or more databases, and/or the like and the mobile aircraft connectivity prediction device, the onboard aircraft connectivity prediction device, the one or more aircraft components during a planned aircraft mission for the aircraft. As another example, a moderate connectivity impact level is associated with a geographic region in which there is predicted to be moderate signal strength between the cloud-based aircraft connectivity prediction device, the one or more databases, and/or the like and the mobile aircraft connectivity prediction device, the onboard aircraft connectivity prediction device, and/or the one or more aircraft components during a planned aircraft mission for the aircraft.

In some embodiments, the plurality of connectivity impact levels includes a severe connectivity impact level. In some embodiments, a severe connectivity impact level is associated with a geographic region in which there is predicted to be severe disruption to communication between a device external to the aircraft and a device within the aircraft during a planned aircraft mission for the aircraft. For example, a severe connectivity impact level is associated with a geographic region in which there is predicted to be severe disruption to communication between the cloud-based aircraft connectivity prediction device, the one or more databases, and/or the like and the mobile aircraft connectivity prediction device, the onboard aircraft connectivity prediction device, and/or the one or more aircraft components during a planned aircraft mission for the aircraft. As another example, a severe connectivity impact level is associated with a geographic region in which there is predicted to be weak signal strength between the cloud-based aircraft connectivity prediction device, the one or more databases, and/or the like and the mobile aircraft connectivity prediction device, the onboard aircraft connectivity prediction device, and/or the one or more aircraft components during a planned aircraft mission for the aircraft.

In some embodiments, the cloud-based aircraft connectivity prediction device, the onboard aircraft connectivity prediction device, and/or the mobile aircraft connectivity prediction device is configured to generate aircraft mission connectivity prediction data by applying aircraft mission connectivity impact data to the aircraft connectivity prediction model. In some embodiments, the cloud-based aircraft connectivity prediction device, the onboard aircraft connectivity prediction device, and/or the mobile aircraft connectivity prediction device is configured to apply aircraft mission connectivity impact data to the aircraft connectivity prediction model after the aircraft connectivity prediction model is trained.

As shown in block 710, the method 700 includes generating an aircraft mission connectivity prediction interface component. As described above, in some embodiments, the aircraft mission connectivity prediction interface component is generated based on aircraft mission connectivity prediction data. In this regard, in some embodiments, the aircraft mission connectivity prediction interface component includes one or more aircraft connectivity zone representations.

In some embodiments, each of the one or more aircraft connectivity zone representations is associated with one of the plurality of connectivity impact levels. For example, each of the one or more aircraft connectivity zone representations corresponds to one of the one or more aircraft connectivity zone items. In this regard, in some embodiments, each of the one or more aircraft connectivity zone representations indicates a connectivity impact level of a plurality of connectivity impact levels for a geographic region associated with a planned aircraft mission of the aircraft. In this regard, for example, an aircraft connectivity zone representation may include text, color, hatching, symbols, and/or the like that indicate that the aircraft connectivity zone representation is associated with a minimal connectivity impact level (e.g., the aircraft connectivity zone representation may be green on the aircraft mission connectivity prediction interface component). As another example, an aircraft connectivity zone representation may include text, color, hatching, symbols, and/or the like that indicate that the aircraft connectivity zone representation is associated with a moderate connectivity impact level (e.g., the aircraft connectivity zone representation may be orange on the aircraft mission connectivity prediction interface component). As another example, an aircraft connectivity zone representation may include text, color, hatching, symbols, and/or the like that indicate that the aircraft connectivity zone representation is associated with a severe connectivity impact level (e.g., the aircraft connectivity zone representation may be red on the aircraft mission connectivity prediction interface component).

In some embodiments, such as illustrated in FIG. 3, the aircraft mission connectivity prediction interface component is associated with an in-flight state. For example, the aircraft mission connectivity prediction interface component may be associated with an in-flight state when the aircraft is in an in-flight portion of an aircraft mission. Said differently, for example, the aircraft mission connectivity prediction interface component may be associated with an in-flight state when the aircraft is located between an originating airport and a destination airport.

In some embodiments, such as illustrated in FIG. 4, the aircraft mission connectivity prediction interface component is associated with an airport state. For example, the aircraft mission connectivity prediction interface component may be associated with an airport state when the aircraft is in a performing preflight procedures portion (e.g., at the gate before a flight), leaving a gate portion, taxiing portion, taking off portion, landing portion, parking at a gate performing post flight procedures portion (e.g., at the gate after a flight) of an aircraft mission. Said differently, for example, the aircraft mission connectivity prediction interface component may be associated with an airport state when the aircraft is located at an originating airport and/or at a destination airport.

As shown in block 712, the method 700 includes causing the aircraft mission connectivity prediction interface component to be rendered to an aircraft operations interface. As described above, in some embodiments, the cloud-based aircraft connectivity prediction device, the onboard aircraft connectivity prediction device, and/or the mobile aircraft connectivity prediction device is configured to cause the aircraft mission connectivity prediction interface component to be rendered to an aircraft operations interface that is provided on the cloud-based aircraft connectivity prediction device, the onboard aircraft connectivity prediction device, the mobile aircraft connectivity prediction device, and/or the one or more aircraft components. For example, the aircraft operations interface may be provided on a multi-function control and display unit.

As shown in optional block 714, the method 700 optionally includes initiating performance of one or more aircraft connectivity related actions. As described above, in some embodiments, the cloud-based aircraft connectivity prediction device, the onboard aircraft connectivity prediction device, and/or the mobile aircraft connectivity prediction device is configured to initiate performance of one or more aircraft connectivity related actions based on the aircraft mission connectivity prediction data.

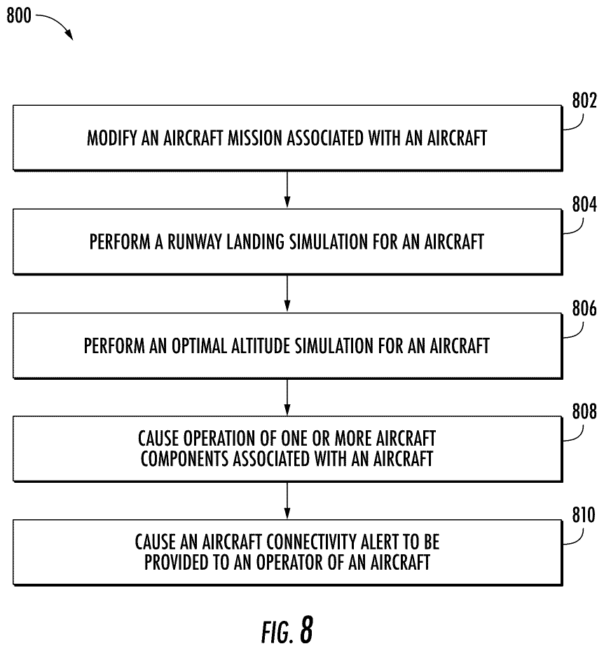

Referring now to FIG. 8, a flowchart providing an example method 800 is illustrated. In this regard, FIG. 8 illustrates operations that may be performed by the cloud-based aircraft connectivity prediction device 140, the mobile aircraft connectivity prediction device 120, an onboard aircraft connectivity prediction device 180, one or more aircraft components 190, and/or one or more databases 170. In some embodiments, the method 800 includes operations for initiating performance of one or more aircraft connectivity related actions. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 800 includes modifying an aircraft mission associated with an aircraft. As described above, in some embodiments, an aircraft mission associated with the aircraft may be modified such that the aircraft avoids a geographic area associated with a moderate connectivity impact level and/or a severe connectivity impact level (e.g., a flight plan of the aircraft is changed to avoid a geographic area associated with a moderate connectivity impact level and/or a severe connectivity impact level).

As shown in block 804, the method 800 includes performing a runway landing simulation for an aircraft. As described above, in some embodiments, a runway landing simulation for the aircraft includes simulating one or more operations that will be performed by the cloud-based aircraft connectivity prediction device, the onboard aircraft connectivity prediction device, the mobile aircraft connectivity prediction device, and/or the one or more aircraft components to land the aircraft (e.g., landing at a destination airport). In some embodiments, initiating performance of one or more aircraft connectivity related actions that includes performing a runway landing simulation for the aircraft may be performed when the aircraft is associated with a minimal connectivity impact level (e.g., when the aircraft is located in a geographic region associated with a minimal connectivity impact level).

As shown in block 806, the method 800 includes performing an optimal altitude simulation for an aircraft. As described above, in some embodiments, an optimal altitude simulation for the aircraft includes simulating one or more operations that will be performed by the cloud-based aircraft connectivity prediction device, the onboard aircraft connectivity prediction device, the mobile aircraft connectivity prediction device, and/or the one or more aircraft components to determine an optimal altitude for the aircraft to operate at during one or more portions of an aircraft mission. In some embodiments, initiating performance of one or more aircraft connectivity related actions that includes performing an optimal altitude for the aircraft may be performed when the aircraft is associated with a minimal connectivity impact level (e.g., when the aircraft is located in a geographic region associated with a minimal connectivity impact level).

As shown in block 808, the method 800 includes causing operation of one or more aircraft components associated with an aircraft. As described above, in some embodiments, initiating performance of one or more aircraft connectivity related actions includes causing operation of a multi-function control and display unit. As another example, initiating performance of one or more aircraft connectivity related actions includes causing operation of a flight management system to cause the aircraft to avoid geographic regions associated with a moderate connectivity impact level and/or a severe connectivity impact level.

As shown in block 810, the method 800 includes causing an aircraft connectivity alert to be provided to an operator of an aircraft. As described above, in some embodiments, an aircraft connectivity alert is an alert provided to an operator of the aircraft that indicates that the aircraft is approaching a geographic region associated with a moderate connectivity impact level and/or a severe connectivity impact level. In this regard, for example, an aircraft connectivity alert may be configured to alert an operator of the aircraft to perform any communications between a device external to the aircraft and a device within the aircraft before entering a geographic region associated with a moderate connectivity impact level and/or a severe connectivity impact level. In some embodiments, an aircraft connectivity alert is an alert provided to an operator of the aircraft that indicates that the aircraft is in a geographic region associated with a moderate connectivity impact level and/or a severe connectivity impact level. In this regard, for example, an aircraft connectivity alert may be configured to alert an operator of the aircraft that communications between a device external to the aircraft and a device within the aircraft may be disrupted.

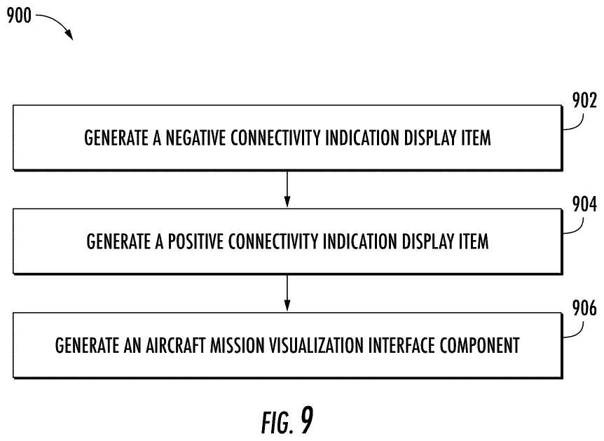

Referring now to FIG. 9, a flowchart providing an example method 900 is illustrated. In this regard, FIG. 9 illustrates operations that may be performed by the cloud-based aircraft connectivity prediction device 140, the mobile aircraft connectivity prediction device 120, an onboard aircraft connectivity prediction device 180, one or more aircraft components 190, and/or one or more databases 170. In some embodiments, the method 900 includes operations for generating an aircraft mission visualization interface component. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900.

As shown in block 902, the method 900 includes generating a negative connectivity indication display item. As described above, in some embodiments, the negative connectivity indication display item is generated based on aircraft mission connectivity prediction data. In this regard, in some embodiments, the negative connectivity indication display item is a display item that includes text, color, hatching, symbols, and/or the like that indicate the aircraft is associated with an aircraft connectivity zone representation that is associated with a moderate connectivity impact level and/or a severe connectivity impact level. Said differently, for example, the negative connectivity indication display item may be configured to indicate that the aircraft is located in a geographic region in which there is moderate and/or severe disruption to communication between a device external to the aircraft and a device within the aircraft.

As shown in block 904, the method 900 includes generating a positive connectivity indication display item. As described above, in some embodiments, the positive connectivity indication display item is generated based on aircraft mission connectivity prediction data. In this regard, in some embodiments, the positive connectivity indication display item is a display item that includes text, color, hatching, symbols, and/or the like that indicate the aircraft is associated with an aircraft connectivity zone representation that is associated with a minimal connectivity impact level. Said differently, for example, the positive connectivity indication display item may be configured to indicate that the aircraft is located in a geographic region in which there is minimal disruption to communication between a device external to the aircraft and a device within the aircraft.

As shown in block 906, the method 900 includes generating an aircraft mission visualization interface component. As described above, in some embodiments, the cloud-based aircraft connectivity prediction device, the onboard aircraft connectivity prediction device, and/or the mobile aircraft connectivity prediction device is configured to generate an aircraft mission visualization interface component. In some embodiments, the aircraft mission visualization interface component is configured to display various aspects of an aircraft mission associated with the aircraft. For example, the aircraft mission visualization interface component may include a representation of the aircraft at the current position of the aircraft. In some embodiments, the aircraft mission visualization interface component includes the negative connectivity indication display item. For example, the aircraft mission visualization interface component may include the negative connectivity indication display item when the aircraft is associated with an aircraft connectivity zone representation that is associated with a moderate connectivity impact level and/or a severe connectivity impact level. Additionally, or alternatively, the aircraft mission visualization interface component includes the positive connectivity indication display item. For example, the aircraft mission visualization interface component may include the positive connectivity indication display item when the aircraft is associated with an aircraft connectivity zone representation that is associated with a minimal connectivity impact level. In some embodiments, the negative connectivity indication display item and/or the positive connectivity indication display item is configured to be selected to display the aircraft mission connectivity prediction interface component.

In some embodiments, the cloud-based aircraft connectivity prediction device, the onboard aircraft connectivity prediction device, and/or the mobile aircraft connectivity prediction device is configured to cause the aircraft mission visualization interface component to be rendered to an aircraft operations interface. In this regard, in some embodiments, the cloud-based aircraft connectivity prediction device, the onboard aircraft connectivity prediction device, and/or the mobile aircraft connectivity prediction device is configured to cause the aircraft mission visualization interface component to be rendered to an aircraft operations interface that is provided on the cloud-based aircraft connectivity prediction device, the onboard aircraft connectivity prediction device, the mobile aircraft connectivity prediction device, and/or the one or more aircraft components. For example, the aircraft operations interface may be provided on a multi-function control and display unit.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
identifying historical aircraft connectivity data;
training an aircraft connectivity prediction model using the historical aircraft connectivity data;
identifying aircraft mission connectivity impact data;
generating aircraft mission connectivity prediction data by applying the aircraft mission connectivity impact data to the aircraft connectivity prediction model;
generating an aircraft mission connectivity prediction interface component, wherein the aircraft mission connectivity prediction interface component comprises one or more aircraft connectivity zone representations, wherein each of one or more aircraft connectivity zone representations is associated with one of a plurality of connectivity impact levels; and
causing the aircraft mission connectivity prediction interface component to be rendered to an aircraft operations interface.

2. The method of claim 1, wherein the aircraft mission connectivity prediction interface component is associated with an in-flight state.

3. The method of claim 1, wherein the aircraft mission connectivity prediction interface component is associated with an airport state.

4. The method of claim 1, further comprising:
initiating performance of one or more aircraft connectivity related actions.

5. The method of claim 4, wherein initiating performance of the one or more aircraft connectivity related actions comprises:
modifying an aircraft mission associated with an aircraft.

6. The method of claim 4, wherein initiating performance of the one or more aircraft connectivity related actions comprises:
performing a runway landing simulation for an aircraft.

7. The method of claim 6, wherein the runway landing simulation is performed when the aircraft is associated with a minimal connectivity impact level of the plurality of connectivity impact levels.

8. The method of claim 4, wherein initiating performance of the one or more aircraft connectivity related actions comprises:
performing an optimal altitude simulation for an aircraft.

9. The method of claim 8, wherein the optimal altitude simulation is performed when the aircraft is associated with a minimal connectivity impact level of the plurality of connectivity impact levels.

10. The method of claim 4, wherein initiating performance of the one or more aircraft connectivity related actions comprises:
causing operation of one or more aircraft components associated with an aircraft.

11. The method of claim 4, wherein initiating performance of the one or more aircraft connectivity related actions comprises:
causing an aircraft connectivity alert to be provided to an operator of an aircraft.

12. The method of claim 1, wherein the aircraft connectivity prediction model comprises a regression learning model.

13. The method of claim 1, further comprising:
generating a negative connectivity indication display item; and
generating an aircraft mission visualization interface component, wherein the aircraft mission visualization interface component comprises the negative connectivity indication display item.

14. The method of claim 1, further comprising:
generating a positive connectivity indication display item; and
generating an aircraft mission visualization interface component, wherein the aircraft mission visualization interface component comprises the positive connectivity indication display item.

15. An apparatus comprising memory and one or more processors communicatively coupled to the memory, the one or more processors configured to:
identify historical aircraft connectivity data;
train an aircraft connectivity prediction model using the historical aircraft connectivity data;
identify aircraft mission connectivity impact data;
generate aircraft mission connectivity prediction data by applying the aircraft mission connectivity impact data to the aircraft connectivity prediction model;
generate an aircraft mission connectivity prediction interface component, wherein the aircraft mission connectivity prediction interface component comprises one or more aircraft connectivity zone representations, wherein each of one or more aircraft connectivity zone representations is associated with one of a plurality of connectivity impact levels; and
cause the aircraft mission connectivity prediction interface component to be rendered to an aircraft operations interface.

16. The apparatus of claim 15, wherein the aircraft mission connectivity prediction interface component is associated with an in-flight state.

17. The apparatus of claim 15, wherein the aircraft mission connectivity prediction interface component is associated with an airport state.

18. The apparatus of claim 15, wherein the one or more processors are further configured to:
initiate performance of one or more aircraft connectivity related actions.

19. The apparatus of claim 15, wherein the aircraft connectivity prediction model comprises a regression learning model.

20. A computer program product comprising at least one non-transitory computer-readable storage medium having computer program code stored thereon that, in execution with at least one processor, configures the computer program product for:
identifying historical aircraft connectivity data;
training an aircraft connectivity prediction model using the historical aircraft connectivity data;
identifying aircraft mission connectivity impact data;
generating aircraft mission connectivity prediction data by applying the aircraft mission connectivity impact data to the aircraft connectivity prediction model;
generating an aircraft mission connectivity prediction interface component, wherein the aircraft mission connectivity prediction interface component comprises one or more aircraft connectivity zone representations, wherein each of one or more aircraft connectivity zone representations is associated with one of a plurality of connectivity impact levels; and
causing the aircraft mission connectivity prediction interface component to be rendered to an aircraft operations interface.
